(19) United States
(12) Patent Application Publication
(10) Pub. No.: US 2020/0164535 A1
(43) Pub. Date: May 28, 2020

(54) Shaving Device

(71) Applicant: Edward Harald de Nijs, De Meern (NL)

(72) Inventor: Edward Harald de Nijs, De Meern (NL)

(21) Appl. No.: 16/777,644

(22) Filed: Jan. 30, 2020

Related U.S. Application Data
(63) Continuation of application No. PCT/NL2018/050492, filed on Jul. 16, 2018.

(30) Foreign Application Priority Data
Aug. 1, 2017 (NL) 2019384

(51) Int. Cl. B26B 21/40; B26B 21/24

(52) U.S. Cl. CPC B26B 21/4062; B26B 21/24

(57) ABSTRACT

A compact shaving device comprising: a substantially flat sliding member to which at least a razor blade is connected which is partly projectable therefrom; a substantially flat holder which is arranged to enable the sliding member longitudinally slidable therein to be moved to desired positions; and control elements having a manually operable knob and means, which are accommodated in the holder and connected to said knob, by means of which the sliding member can be moved in the longitudinal direction, causing the said razor blade to be positioned in adjustable sliding positions.

### CROSS-REFERENCE TO RELATED APPLICATIONS

This application is a continuation of International Patent Application No. PCT/NL2018/050492, entitled “Shaving Device”, filed on Jul. 16, 2018, which claims priority to Netherlands Patent Application No. 2019384, entitled “Shaving Device”, filed on Aug. 1, 2017, and the specification and claims thereof are incorporated herein by reference.

### BACKGROUND OF THE INVENTION

The present invention relates to a shaving device.

Shaving devices for trimming or shaving, for example, a beard or moustache are available in many types and designs. For example, there are electrically powered but also hand-operated shaving devices. The latter category includes, for example, devices where the generally known razor blade is clamped by means of a mechanism which is situated at the end of a handle. At the other end of the handle there is a rotary knob which is used to operate the said mechanism in order to release, or secure and cover the razor blade with the exception of a protruding cutting edge for dry or wet shaving, as desired.

A drawback of the known shaving devices resides in that they take up a comparatively large amount of space.

### BRIEF SUMMARY OF THE INVENTION

It is an object of the embodiments of the present invention to provide an improved shaving device, which is compact, easy to take along and which takes up less of the available space.

To achieve this, the embodiments of the shaving device according to the invention is characterized in that it comprises:
a substantially flat sliding member to which at least a razor blade is connected which is partly projectable therefrom,
a substantially flat holder which is arranged to enable the sliding member longitudinally slidable therein to be moved to desired positions, and
control elements having a manually operable knob and means, which are accommodated in the holder and connected to said knob, by means of which the sliding member can be moved in the longitudinal direction, causing the said razor blade to be positioned in adjustable sliding positions.

An advantage of the embodiments of the shaving device according to the invention resides in that it is substantially flat as well as compact, as a result of which it takes up only a small amount of space and is easy to take along. Moreover, in the non-operational state, wherein the sliding member together with the razor blade are fully retracted, the razor blade is safely stored. In addition, the sliding member cannot accidentally change to the operational state, in which the razor blade projects from the holder, because this requires the knob being moved deliberately. By virtue thereof, the safety of the shaving device according to the invention is increased, also when it is carried on the body or, in particular, in clothing or, for example in a rucksack. Because it takes up a limited amount of the available space, and its own weight is low, the shaving device according to the invention is very suitable for use by, for example, military in the field, people making comparatively long hiking tours through vast, uninhabited regions, or astronauts who remain in space for a long time or people who are left to their own devices for a long period of time.

Further detailed, possible embodiments explained in the other claims are mentioned, together with the associated advantages, in the following description.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a perspective view of a first embodiment of a shaving device according to an embodiment of the present invention of a sliding knob type;

FIGS. 2a, 3a, 4a, 5a, 6a and 2b, 3b, 4b, 5b, 6b, respectively, show flat holders comprising flat sliding members slidably arranged therein, in which various types of slots and guiding openings are provided of other embodiments of the shaving device of the type shown in FIG. 1, according to embodiments of the present invention;

FIGS. 7a, 8a and 7b, 8b, respectively show front sides and rear sides of sliding members, each exhibiting part of a sliding knob, and FIGS. 7c and 8c show side views thereof with details exhibiting the way in which the razor blade(s) is(are) connected to the sliding member of the shaving device of the type mentioned above, according to embodiments of the present invention;

FIGS. 9a and 9b show a holder and an associated sliding member of a second embodiment of the shaving device according to an embodiment of the present invention comprising a rotatable knob with an eccentric guiding part; and

FIGS. 10a and 10b show a holder and an associated sliding member of a third embodiment of a shaving device according to the present invention comprising a rotatable knob with a spindle.

### DETAILED DESCRIPTION OF THE INVENTION

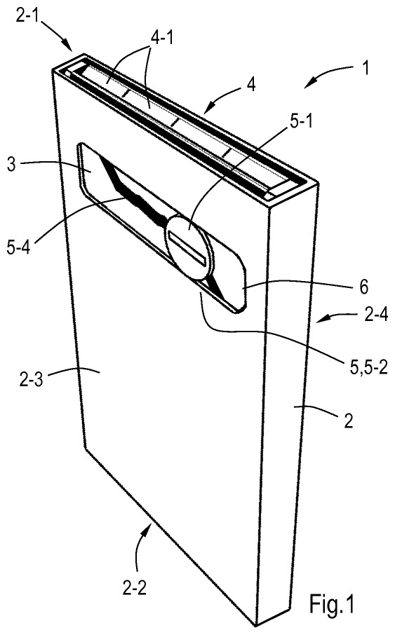

FIG. 1 is a perspective view of a shaving device 1 according to an embodiment of the present invention. This shaving device comprises a flat holder 2 having an open end face 2-1 and/or an oppositely located open end face 2-2. The shaving device 1 further comprises a substantially flat sliding member 3 which is slidably arranged in the holder 2, and a razor blade 4 which partially projects from the sliding member 3 and which is rigidly or detachably fixed to said sliding member. In addition, the device comprises control elements 5 including a manually operable knob 5-1 and means 5-2 arranged in the holder 2 and connected to the knob 5-1, said means enabling the sliding member 3 to be moved in the longitudinal direction, thereby allowing said razor blade 4 to adopt adjustable sliding positions inside and in particular through and outside the respective end face 2-1, 2-2.

The knob 5-1, which can be moved substantially transversely, is operated manually in the cases shown in FIGS. 1 through 6. The holder 2 has a slot 6 in which the knob 5-1 can be slidably positioned. If necessary, the sliding knob 5-1 can be positioned in the slot 6 in a clamping manner. This also applies to the embodiments of the type of shaving device having a sliding knob 5-1, which will be explained hereinafter. This type of shaving device 1 has a guiding part 5-3 situated below, and moving with, the knob (see FIGS. 7b and 9b). The above-mentioned means 5-2, on the other hand, comprise a guiding opening 5-4, which is formed in the sliding member 3 and into which said guiding part 5-3 is inserted. When the knob 5-1 is moved in a transverse direction, the guiding part 5-3 thereof presses on the opening 5-4, causing the sliding member 3 to move upwards or downwards in FIGS. 1-6, dependent on the direction of movement of the knob 5-1 and the course of the guiding opening 5-4. As a result, when the knob 5-1 is moved, said razor blade 4 adopts adjustable sliding positions, at least at one of the two end faces 2-1, 2-2 of the holder 2 of the shaving device 1.

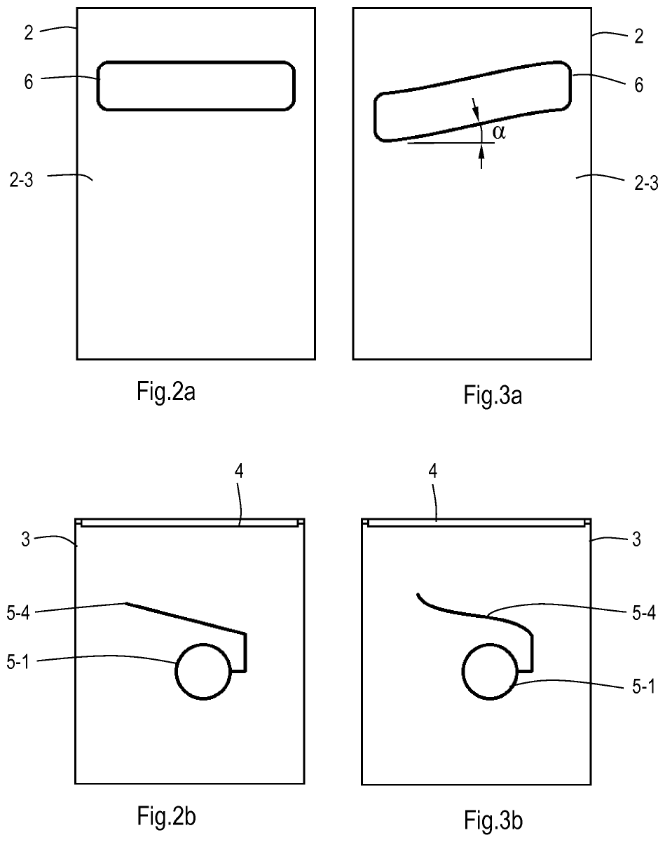

FIGS. 2a and 2b show, in particular, an embodiment of the said type having a straight slot 6 in the holder 3 and a straight guiding opening 5-4. By moving the knob 5-1, diagrammatically shown in FIG. 2b, to the left in the slot 6, the sliding member 3 with the knife 4 is made to disappear inside the holder 3 and vice versa.

Likewise, the slot 6 and the guiding opening 5-4 shown in FIGS. 3a and 3b are slightly curved.

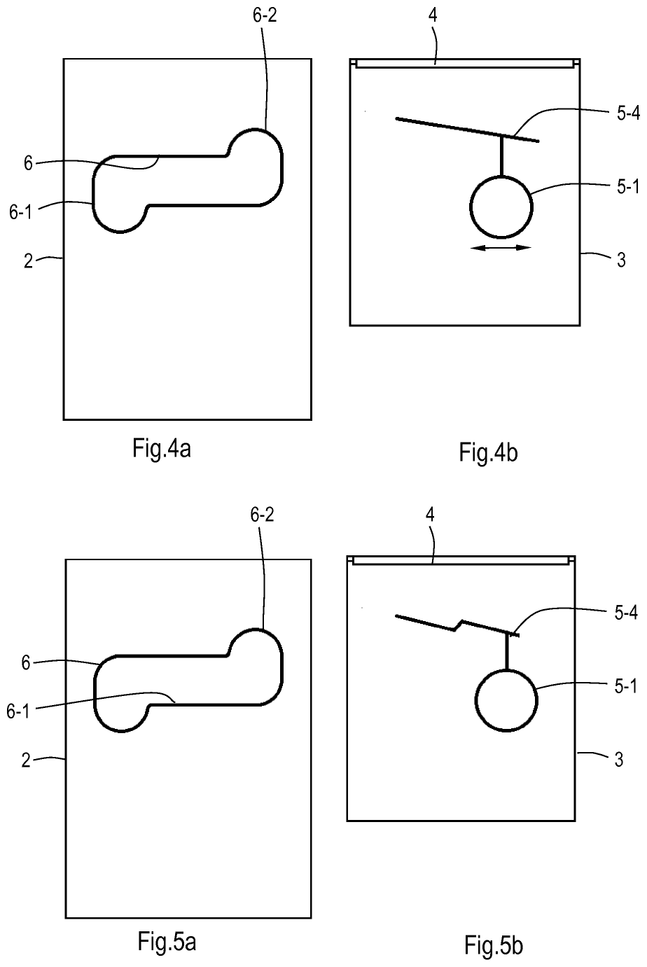

In the embodiment shown in FIGS. 4a and 4b, at the location of widened end portions 6-1, 6-2 of slot 6, the knob 5-1 can be moved stepwise, in longitudinal direction, slightly inwards and outwards, respectively, wherein the guiding opening 5-4 is continuous. By virtue thereof, the sliding member 3 and the razor blade 4 jointly move into or out of the holder 2, respectively.

In the next embodiment of FIGS. 5a and 5b, at the location of widened end portions 6-1, 6-2 of slot 6, the knob 5-1 can be moved stepwise, in longitudinal direction, slightly inwards and outwards, respectively, wherein the guiding opening 5-4 is discontinuous, resulting in the same outcome as explained with respect to the preceding embodiment.

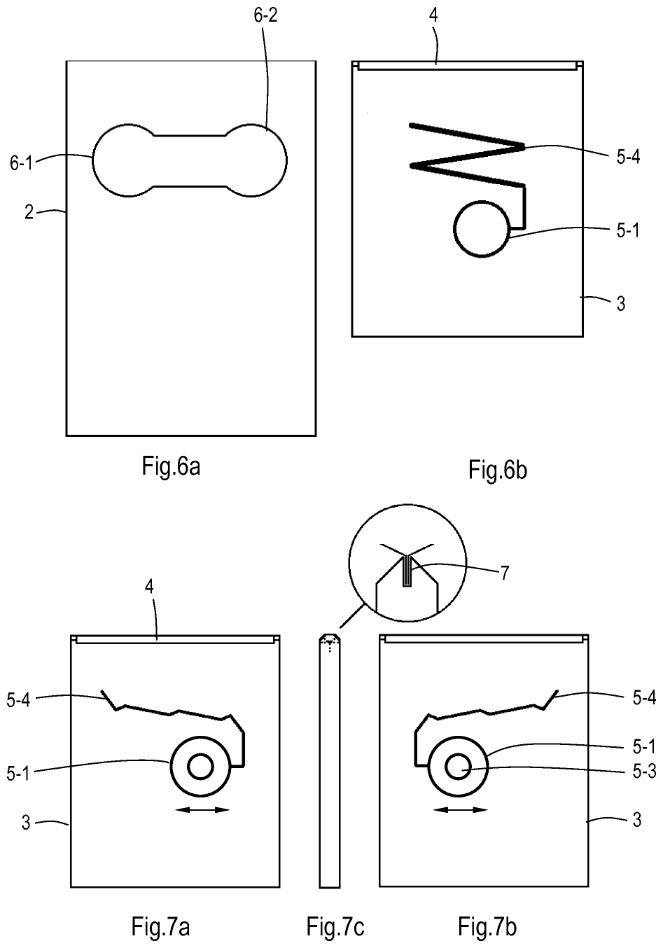

In a further embodiment of said type show in FIGS. 6a and 6b, the slot 6 is dumbbell-shaped with widened end portions 6-1, 6-2 as well, and the guiding opening 5-4 is zigzag-shaped or saw tooth-shaped. By virtue thereof, when the sliding knob 5-1 is moved, a required change in position of the razor blade 4 is achieved.

The holder 2 comprises two opposite sides 2-3, 2-4 which are substantially flat. The embodiments explained hereinabove can be provided with a corresponding slot 6 on either one of the flat sides or on both flat sides 2-3, 2-4.

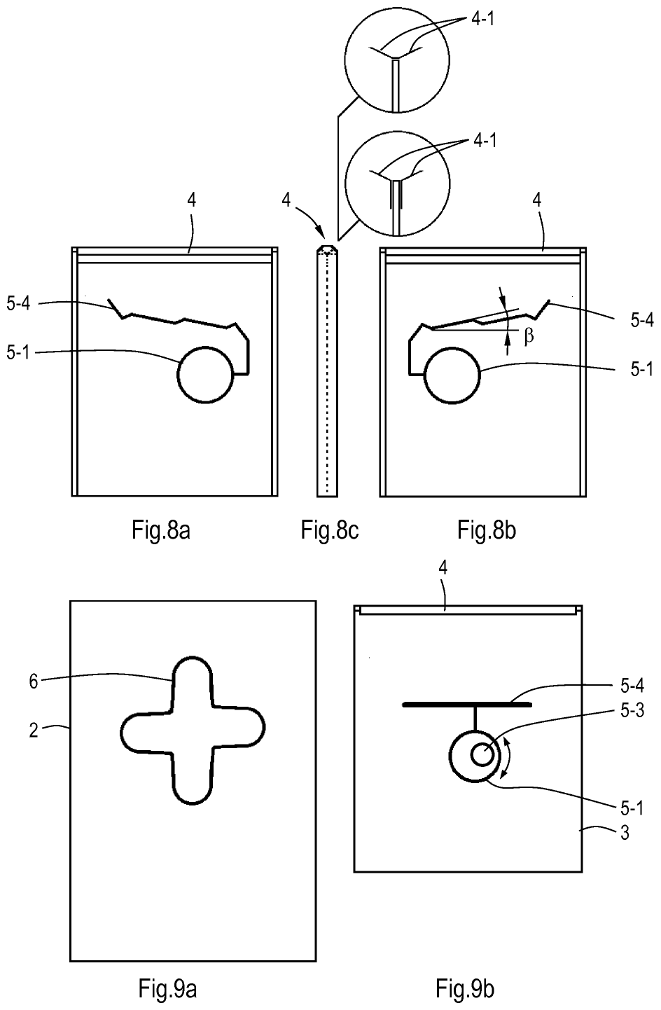

In the latter case, as shown in the embodiment depicted in FIGS. 7a, 7b and 8a, 8b, both sides 2-3, 2-4 of the holder 3 are provided with the correspondingly located slot 6, in which case the single sliding knob 5-1, which can be operated on both sides, and the guiding part 5-3 of which extends through the guiding opening 5-4, can be moved manually. This has the advantage that the knob 5-1, which is held between the thumb on one side, 2-3, and the forefinger on the other side, 2-4, can be operated in a simple manner by exerting a squeezing force. FIGS. 7c and 8c in combination with the depicted details show how the razor blade 4 or superposed razor blades 4, which may have a flanged edge 4-1 or which may be V-shaped in situ, are connected to the end portion of the sliding member 3. If necessary, said end portion may be provided with a cavity 7 (detail of FIG. 7) in which the razor blades 4 are, detachably or non-detachably, secured. The angle α (FIG. 3a) which, if necessary, the slot 6 includes with a transverse direction in combination with the angle β (FIG. 8b) which at least part of the guiding opening 5-4 includes with a transverse direction, determine the extent to which the sliding member 3 together with the razor blades 4 pass through the respective end face(s) 2-1 and/or 2-2 towards the exterior or the interior.

FIGS. 9a and 9b show the holder 2 and the associated sliding member 3 of a second embodiment of the shaving device 1. The means 5-2 of the control elements 5 have, in this case, a rotatable knob 5-1 with a depicted, eccentric guiding part 5-3 which, underneath the knob, fits into the guiding opening 5-4 of the sliding member 3. Said knob 5-1 is rotatable about an axis which extends perpendicularly to the plane of the sliding member 3. Upon rotation of the knob 5-1, the abovementioned razor blade 4 adopts adjustable sliding positions as a result of the guiding part 5-3 being moved in the guiding opening 5-4. If necessary, said knob 5-1 can be a tight fit in the cross-shaped slot 6 which has slightly tapering end portions.

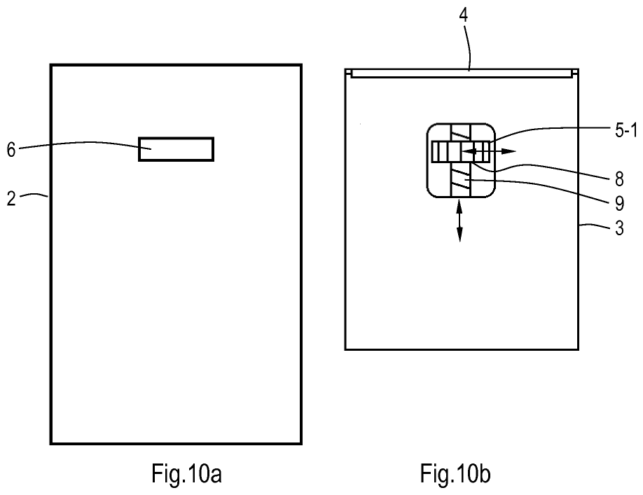

FIGS. 10a and 10b show the holder 2 and the associated sliding member 3 of a third embodiment of the shaving device 1. The means 5-2 of the control elements 5 have, in this case, a rotatable knob 5-1. Said knob 5-1, which is enclosed in the slot 6 in the holder 2 is rotatable about an axis, in this case, which extends in the longitudinal direction and in the plane of the sliding member 3. The knob 5-1 comprises a threaded hole 8 through which the means 5-2 pass, which, in this case, are in the form of a spindle 9 which extends in the longitudinal direction and which is connected to the sliding member 3. Upon rotation of the enclosed knob 5-1, the spindle 9 and hence the sliding member 3 are moved in the longitudinal direction, causing the abovementioned razor blade to adopt adjustable sliding positions.

Preferably, for all types and all embodiments of the knob 5-1 explained hereinabove, it applies that the top surface runs substantially parallel to the plane or planes of the substantially flat holder 2, so that said holder has substantially no projecting parts and is easy to store.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. Note that in the specification and claims, “about” or “approximately” means within twenty percent (20%) of the numerical amount cited.

1. A shaving device comprising:
a sliding member to which at least one razor blade is connected, wherein the sliding member is substantially flat and wherein the at least one razor blade is at least partially projectable from the sliding member;
a holder arranged to enable the sliding member to be slidable in a longitudinal direction therein and to be movable to desired positions, wherein the holder is substantially flat; and
control elements comprising a manually operable knob and means for moving the sliding member in the longitudinal direction, wherein the means for moving the sliding member are accommodated in the holder and connected to the knob, and wherein the means for moving the sliding member are configured to cause the at least one razor blade to be positioned in adjustable sliding positions.

2. The shaving device according to claim 1, wherein the knob is either substantially slidable in a transverse direction and/or rotatable.

3. The shaving device according to claim 2, wherein the knob comprises a guiding part which moves with the knob, and the means for moving the sliding member form a guiding opening in the sliding member, wherein the shaving device is arranged such that when the knob slides, the at least one razor blade is caused to be positioned in the adjustable sliding positions.

4. The shaving device according to claim 2, wherein the shaving device comprises a first open end face and a second open end face and is arranged such that the at least one razor blade can adopt slide-out positions at one or at each one of the open end faces of the holder.

5. The shaving device according to claim 2, wherein the holder comprises a slot in which the knob can be positioned.

6. The shaving device according to claim 5, wherein the holder comprises two oppositely located, substantially flat sides, one or both of which are provided with the slot.

7. The shaving device according to claim 6, wherein both sides of the holder comprise a correspondingly located slot, in which the knob can be moved manually.

8. The shaving device according to claim 2, further comprising an eccentric guiding part located underneath the knob, the knob being rotatable about an axis which extends perpendicularly to the plane of the sliding member, wherein the means for moving the sliding member comprise an opening through which the rotatable eccentric guiding part projects in such a manner that upon rotation of the knob, the at least one razor blade adopts adjustable sliding positions as a result of the guiding part being moved in the guiding opening.

9. The shaving device according to claim 2, wherein the knob comprises a threaded hole through which the means for moving the sliding member protrude, wherein the means for moving the sliding member comprise a spindle which extends in the longitudinal direction and which is connected to the sliding member in such a manner that rotation of the knob causes the at least one razor blade to be positioned in the adjustable sliding positions as a result of the sliding movement of the spindle.

10. The shaving device according to claim 1, wherein the sliding member comprises a cavity for rigidly fixing the at least one razor blade.

11. The shaving device according to claim 1, wherein the sliding member comprises two flat portions between which the at least one razor blade is capable of being disposed.

12. The shaving device according to claim 1, wherein the at least one razor blade comprises at least one edge configured to project from the shaving device.

13. The shaving device according to claim 1, wherein the sliding member can be removed from the holder, and the sliding member is detachably connected to the razor blade.

14. The shaving device according to claim 1, wherein the shaving device comprises synthetic resin and/or metal.

15. The shaving device according to claim 1, wherein the top surface of the knob runs substantially parallel to the plane or planes of the holder.

16. The shaving device according to claim 5 wherein the knob is positioned in the slot in a clamping manner.

17. The shaving device according to claim 12 wherein the edge comprises a flange.

18. The shaving device according to claim 17 wherein the at least one razor blade comprises two razor blades lying on top of one another, and the flanges of the razor blades point in opposite directions.

19. The shaving device according to claim 14 wherein the metal is aluminium.
